(19) United States
(12) Patent Application Publication
(10) Pub. No.: US 2022/0358539 A1
(43) Pub. Date: Nov. 10, 2022

(54) SYSTEMS AND METHODS FOR MANAGING ADVERTISEMENTS IN SOCIAL NETWORKS

(71) Applicant: Alexey Bozhin, Novi Sad (RS)

(72) Inventor: Alexey Bozhin, Novi Sad (RS)

(21) Appl. No.: 17/308,075

(22) Filed: May 5, 2021

(51) Int. Cl. G06Q 30/02; G06Q 50/00

(52) U.S. Cl. CPC G06Q 30/0254; G06Q 50/01; G06Q 30/0272; G06Q 30/0246; G06Q 30/0276

(57) ABSTRACT

Methods and systems for managing advertisements in social networks are provided. An example method commences with receiving, from a user, a publishing time and a social network post to be published in one or more accounts of the user in one or more social networks. The method includes, prior to publishing the social network post, associating the social network post with a rule for enabling advertisement of content. The rule is based partially on statistics to be associated with the social network post. The method includes, after publishing the social network post in the one or more social networks at the publishing time, continuously monitoring the statistics associated with the published social network post to determine, based on the statistics, that the rule is satisfied. In response to the determination that the rule is satisfied, the advertisement of content is enabled in the one or more social networks.

### TECHNICAL FIELD

This disclosure generally relates to the field of social networks. More particularly, this disclosure relates to methods and systems for managing advertisements in social networks.

### BACKGROUND

Social networks are widely used for communications between users, publishing content, and providing advertisement. Currently, social networks allow associating advertisement only with already published posts, messages, videos, and other content. Additionally, a user having multiple accounts in multiple social networks has to associate advertisements separately in each of the accounts. Therefore, there is a need for a convenient way for managing advertisements in social networks.

### SUMMARY

This section introduces a selection of concepts in a simplified form that are further described in the Detailed Description section, below. This summary does not identify key or essential features of the claimed subject matter and is not intended to be an aid in determining the scope of the claimed subject matter.

This present disclosure is directed to systems and methods for managing advertisements in social networks. Some embodiments of the present disclosure may facilitate users to configure and enable advertisements in postponed social network posts. According to one example embodiment, a method for managing advertisements in social networks is provided. The method may commence with receiving, from a user, a publishing time and a social network post to be published in one or more accounts of the user in one or more social networks. The method may further include, prior to publishing the social network post, associating the social network post with a rule for enabling advertisement of content.

In some embodiments, a user interface may be provided to the user to allow the user to select the rule from a list of predetermined rules. The rule may be based partially on statistics associated with the social network post. In further embodiments, a user interface may be provided to the user to allow the user to create and edit the rule.

The method may further include, after publishing the social network post in the one or more social networks at the publishing time, continuously monitoring the statistics associated with the published social network post to determine, based on the statistics, that the rule is satisfied. The statistics may be monitored via an application programming interface of the one or more social networks. In some embodiments, the statistics may be monitored by reading a page of an Internet browser that includes the published social network post in the one or more social networks.

The determination that the rule for enabling the advertisement content is satisfied may include determination of one or more of the following: determination that a current time exceeds the publishing time by a predetermined value, determination that the published social network post has been viewed a predetermined number of times, determination that the published social network post has received a predetermined number of reactions, determination that the published social network post has received a pre-determined number of comments, and so forth. In response to the determination that the rule is satisfied, the advertisement of the content may be enabled in the one or more social networks.

Enabling the advertisement of the content may include requesting that the social networks advertise the social network post. Enabling the advertisement of the content may also include requesting advertisement of the social network post in a further social network post in the one or more further accounts of a further user in the one or more social networks. After advertisement of the social network post, a reward may be awarded to the further user.

According to another example embodiment, a system for managing advertisements in social networks is provided. The system may include at least one processor and a memory storing processor-executable codes. The processor can be configured to implement the operations of the above-mentioned method for managing advertisements in social networks.

According to yet another aspect of the disclosure, there is provided a non-transitory processor-readable medium, which stores processor-readable instructions. When the processor-readable instructions are executed by a processor, they cause the processor to implement the above-mentioned method for managing advertisements in social networks.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements.

FIG. 1 is a block diagram showing an example environment, in which a post and advertisement managing system and a method for managing advertisements in social networks can be implemented.

FIG. 2 is a block diagram showing modules of a post and advertisement managing system, according to an example embodiment.

FIG. 3 is a schematic showing a timeline of operations of a post and advertisement managing system, according to an example embodiment.

FIGS. 4 is a flow chart showing a method for managing advertisements in social networks, according to an example embodiment.

FIGS. 5 is a flow chart showing a method for enabling advertisements in social networks, according to an example embodiment.

FIG. 6 is a high-level block diagram illustrating an example computer system, within which a set of instructions for causing the machine to perform any one or more of the methodologies discussed herein can be executed.

### DETAILED DESCRIPTION

The following detailed description of embodiments includes references to the accompanying drawings, which form a part of the detailed description. Approaches described in this section are not prior art to the claims and are not admitted to be prior art by inclusion in this section. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

The technology described herein is concerned with systems and methods for managing advertisements in social networks. Some embodiments of the present technology may facilitate a user to manage posts and advertisements associated with the posts in multiple social networks. More specifically, some embodiments of the present disclosure may allow generating rules for enabling advertisements in postponed posts in social networks based on statistics of the postponed posts, where the statistics are collected after the posts become published. The systems and methods enable the user to simultaneously provide posts for postponed publishing in social networks and create or select rules for enabling advertisement of content for the posts after publishing when the statistics of the posts meet the rules. Enabling advertisement may include requesting that the social networks advertise the published posts. Enabling advertisement may also include requesting that other users advertise the published post in accounts of the other users in the social networks.

According to an example embodiment of the present disclosure, a system for managing advertisements in social networks may include one or more processors and a memory in communication with the one or more processors and storing processor-executable codes. The one or more processors may be configured to receive, from a user, a publishing time and a social network post to be published in one or more accounts of the user in one or more social networks. Before the social network post is published, the social network post may be associated with a rule for enabling advertisement of content. The rule may be based at least partially on statistics associated with the social network post in the one or more social networks. After the social network post is published in the one or more social networks at the publishing time, the statistics associated with the published social network post in the one or more social networks may be continuously monitored. Based on the statistics, it may be determined that the rule for enabling the advertisement of the content is satisfied. In response to the determination that the rule for enabling the advertisement of the content is satisfied, the advertisement of the content may be enabled in the one or more social networks of the user.

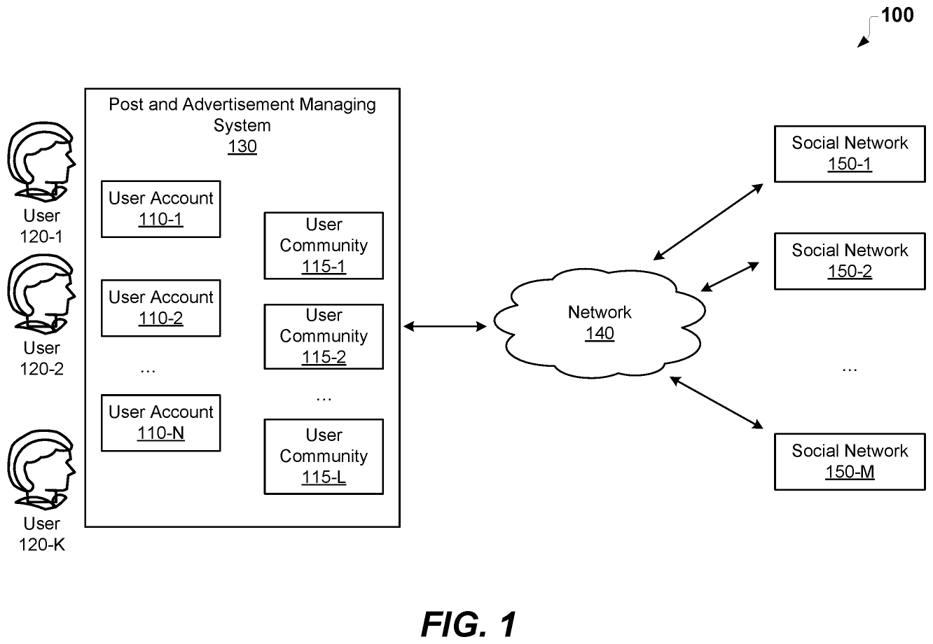

Referring now to the drawings, FIG. 1 shows an example environment 100, in which a system and a method for managing advertisements in social networks can be implemented. The environment 100 may include a post and advertisement managing system 130 (also referred herein as a system for managing advertisements in social networks); a plurality of user accounts 110-1, 110-2, . . . , 110-N; a plurality of user communities 115-1, 115-2, . . . , 115-L; a plurality of users 120-1, 120-2, . . . , 110-K associated with the plurality of user accounts 110-1, 110-2, . . . , 110-N and the plurality of user communities 115-1, 115-2, . . . , 115-L; a data network 140; and a plurality of social networks 150-1, 150-2, . . . , 150-M.

In an example embodiment, the users 120-1, 120-2, . . . , 110-K may include a person, a company, a brand, or other entity having one or more accounts in one or more of the social networks 150-1, 150-2, . . . , 150-M. The users 120-1, 120-2, . . . , 110-K may access and administer the accounts in the social networks 150-1, 150-2, . . . , 150-M. The users 120-1, 120-2, . . . , 110-K may access the user accounts 110-1, 110-2, . . . , 110-N and user communities 115-1, 115-2, . . . , 115-L in the post and advertisement managing system 130, a personal computer (PC), a laptop, a smartphone, a tablet PC, a personal wearable device, and so forth. The users 120-1, 120-2, . . . , 110-K may be registered, i.e., may have accounts, in the social networks 150-1, 150-2, . . . , 150-M.

The social networks 150-1, 150-2, . . . , 150-M may include social networking web sites or online platforms used by social network users to build social networks and/or social relationships with other social network users based on similar interests, activities, real-life connections, or other parameters. The social networks 150-1, 150-2, . . . , 150-M allow the users to share digital content in various forms, such as text, images, audio, video, and any combinations of text, images, audio, and video. The shared digital content of a user may be shown by the social networks 150-1, 150-2, . . . , 150-M to users having some relationships with the user or to other predetermined groups of users based on functionalities provided by the social networks 150-1, 150-2, . . . , 150-M.

In an example embodiment, the social networks 150-1, 150-2, . . . , 150-M may include application programming interfaces (APIs) or other software clients, tools, or protocols configured to interface with external applications and provide interactions between the social networks 150-1, 150-2, . . . , 150-M and the external applications.

In an example embodiment, the system 130 may include any of a server, a cloud-based computing resource, an application running on the user devices and so forth. The system 130 may receive a social network post and publishing time for the social network post from a user 120-i. Upon providing the social network post and before the network post is published in one or more of the social networks 150-1, 150-2, . . . , 150-M, the user 120-i may create or select a rule for enabling advertisement of content. The content can be provided by a user other than the user 120-i. At the publishing time, the system 130 may publish the social network post in one or more social networks 150-1, 150-2, . . . , 150-M selected by the user 120-i. In an example embodiment, the system 130 communicates with the social networks 150-1, 150-2, . . . , 150-M via APIs associated with the social networks 150-1, 150-2, . . . , 150-M.

After the social network post is published in one or more of the social networks 150-1, 150-2, . . . , 150-M, the system 130 may continuously monitor statistics associated with the published social network post in the one or more social networks 150-1, 150-2, . . . , 150-M. Based on the monitoring, the system 130 may determine whether the rule for enabling the advertisement of the content is satisfied. The monitoring may be based on the statistics associated with the published social network post. When the system 130 determines that the rule is satisfied, the system 130 enables the advertisement of the content in the one or more social networks 150-1, 150-2, . . . , 150-M.

The system 130 may communicate with the plurality of social networks 150-1, 150-2, . . . , 150-M via the data network 140. The data network 140 may include the Internet or any other network capable of communicating data between devices. Suitable networks may include or interface with any one or more of, for instance, a local intranet, a corporate data network, a data center network, a home data network, a Personal Area Network, a Local Area Network (LAN), a Wide Area Network (WAN), a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications using the data network 140 may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network 140 can further include or interface with any one or more of a Recommended Standard 232 (RS-232) serial connection, an IEEE-1394 (FireWire) connection, a Fiber Channel connection, an IrDA (infrared) port, a Small Computer Systems Interface connection, a Universal Serial Bus (USB) connection or other wired or wireless, digital or analog interface or connection, mesh or Digi® networking.

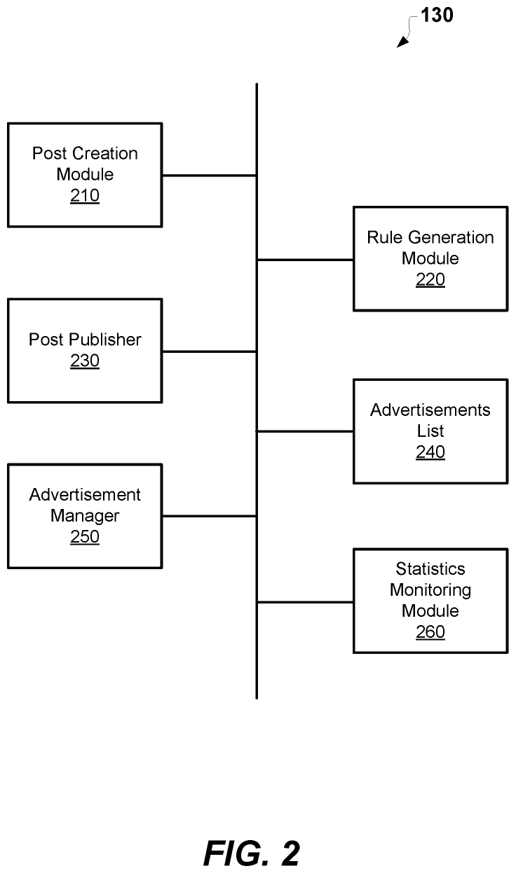

FIG. 2 is a block diagram showing modules of a post and advertisement managing system 130, according to an example embodiment. The post and advertisement managing system 130 may include a post generation module 210, a rule generation module 220, a post publisher 230, an advertisement list 240, an advertisement manager 250, and a statistics monitoring module 260. In an example embodiment, the modules 210-260 can be implemented by processor-executable code stored in a memory of the system 130 and executed by one or more processors of the system 130.

The post generation module 210 may be configured to provide a user interface for creation and editing of a social network post, receiving publishing time for the social network post, and receiving a list of social networks in which the social network post needs to be published. In an example embodiment, the publishing time for the social network post can be different for different social networks. Therefore, receiving the publishing time may include receiving an individual publishing time for each of the social networks.

The user may also use APIs or other tools of the social networks to connect accounts of the user in the social networks to the system 130. The user may have a plurality of accounts in multiple social networks, such as Facebook®, Instagram®, Twitter®, YouTube®, Telegram®, LinkedIn®, and so forth. As used herein, the term “social networks” further include messaging applications, such as Facebook Messenger®, WhatsApp®, Viber®, and so forth. The user may connect all accounts of the user in the social networks to the system 130.

The rule generation module 220 may be configured to generate a rule for enabling advertisement of content. The content can be provided by a different user. The rule is generated before the social network post is published. The rule may depend on statistics collected for the social network post after the social network post has been published in the social networks. The user may select the rule from a list of predetermined rules. The rule generation module 220 may provide a plurality of predetermined rules for selection by the user.

Alternatively, the user may create the rule by himself by setting parameters of the rule. In some embodiments, the rule generation module 220 may provide recommendations on the parameters of the rule for the user. In some embodiments, the rule generation module 220 may provide a template for the rule. To create the rule, the user may edit the template by changing or setting parameters of the rule.

The rule may be based on statistics collected for the social network post after the social network post has been published in the social networks. The statistics may include a plurality of parameters, such as reactions given by users to the social network post (e.g., likes, dislikes), a number of views of the social network post by users, time passed after publishing of the social network post, a number of comments on the social network post by users, a name of a social network, a source of the advertisement content (the social networks or the system 130), and combinations of the parameters. For the same social network post, different rules for different social networks may be set. For example, the user may set the rule to enable the advertisement of content for the social network post in a first social network at a specific time period of the day (e.g., evening hours when users of the first social network are historically most active in the first social network). For the same social network post, the user may set the rule to enable the advertisement of content in a second social network after the social network post has received a predetermined number of reactions. In some embodiments, the user may select the rule to enable the advertisement of content immediately after publishing the social network post in the social network.

By setting the parameters of the rule, the user may select statistics data that need to be collected for the social network post and threshold values (i.e., values of the statistics data when the rule is satisfied) for each type of the statistics data.

In an example embodiment, the user may indicate which advertisement content needs to be enabled when the rule is satisfied; i.e., the user may select a source of the advertisement content. Specifically, the user may choose to use the advertisement content provided by the social networks. In this embodiment, the APIs or other clients/tools of the social networks may be used to select and/or enable the advertisement content for the social network post.

In a further example embodiment, the user may choose to use the advertisement content provided by the system 130. The advertisement content provided by the system 130 may be provided by third parties (e.g., companies, brands, bloggers, influencers, or other users). The third parties may include one or more user accounts 110-1, 110-2, . . . , 110-N and user communities 115-1, 115-2, . . . , 115-L registered in the system 130 as advertisement content providers. The system 130 may enable the third parties to use the social network post of the user as the advertisement content. Specifically, upon meeting the rule by the published social network post of the user, the social network post may be provided to the third party. The third party may publish the social network post in an account of the third party as a further social network post. In further embodiments, the third party may add a link to the social network post in a further social network post published in the account of the third party in the social networks. In some embodiments, the third party may add the social network post or a portion of the social network post into a further social network published in the account of the third party in the social network. The third party may receive an award for publishing the social network post or a further social network post that includes a link to or is associated with the social network post of the user.

The post publisher 230 may be configured to send the social network post using APIs of the social networks and configure the social networks, via the APIs, to publish the social network post at the publishing time.

The statistics monitoring module 260 may be configured to periodically collect statistics associated with the social network post (e.g., likes/dislikes, views, comments, reposting, sending the social network post in private messages, and so forth) during a pre-determined time period after the social network post has been published. Based on the statistics, the statistics monitoring module 260 may determine whether the rule is satisfied or not satisfied. To collect the statistics, the statistics monitoring module 260 may analyze a page of the social network post in an Internet browser. In further example embodiments, the statistics monitoring module 260 may request the statistics from the social networks using the APIs.

The advertisement manager 240 may be configured to enable the advertisement of content in the social network post when the rule is satisfied. If the advertisement content is selected to be an advertisement provided by the social networks, the advertisement manager 250 uses the APIs of the social networks to enable the social networks to provide the advertisement content associated with the social network post. If the advertisement content is selected to be an advertisement provided by the system 130, the advertisement manager 250 may publish the advertisement content as a further social network post in the account of the user in the social networks and award a reward to the user. In some embodiments, the advertisement manager 250 may publish the advertisement content associated with the social network post as a further social network post in an account of a further user (a third party, such as an influencer in social networks) in the social networks and award a reward to the further user.

The advertisement manager 250 may be further configured to allow users to create and edit advertisement content (in form of a post) and store the advertisement content in the advertisement list 240. The advertisement list 240 may store the advertisement content provided by the users of the system 130. In some embodiments, the advertisement list 240 may store the social network post as the advertisement content.

In an example embodiment, enabling the advertisement content for the social network post may include publishing the social network post in one or more social networks as a sponsored publication. Specifically, the one or more social networks may publish the social network post as the sponsored publication in a news feed of a plurality of users selected by the one or more social networks as a target audience for the social network post. In some embodiments, the user may select the target audience by setting the parameters of the rule.

In a further example embodiment, the advertisement content may include one or more of a hyperlink, text, image, video, audio, and any combinations of the hyperlink, text, image, video, and audio. The advertisement content may be enabled for the social network post by providing a banner with the advertisement content integrated into the social network post, pausing the social network post (e.g., if the social network post is a video file) and playing the advertisement content (e.g., if the advertisement content is in a video format), partially overlaying the social network post with the advertisement content, adding a hyperlink to the social network post, and so forth.

In a further example embodiment, enabling the advertisement of content for the social network post may include sending the social network post as a message in one or more messaging applications to a group of users that are selected as a target audience for the social network post.

Therefore, a user may use the system 130 for creating social network posts, planning postponed publishing of the social network posts in one or more social networks, and enabling the advertisement of content for the social network posts (e.g., by providing the social network posts as the advertisement content to a plurality of users) when the rule for enabling the advertisement of content is satisfied. Accordingly, the user may create a schedule for postponed publishing of the social network posts in social networks and may select a rule when the advertisement of content needs to be enabled for the social network posts after the social network posts have been published. Therefore, the system 130 may automatically switch on advertising associated with social network posts of the user. Thus, the user does not need to manually enable advertising for each social network post of the user after the social network post have been published.

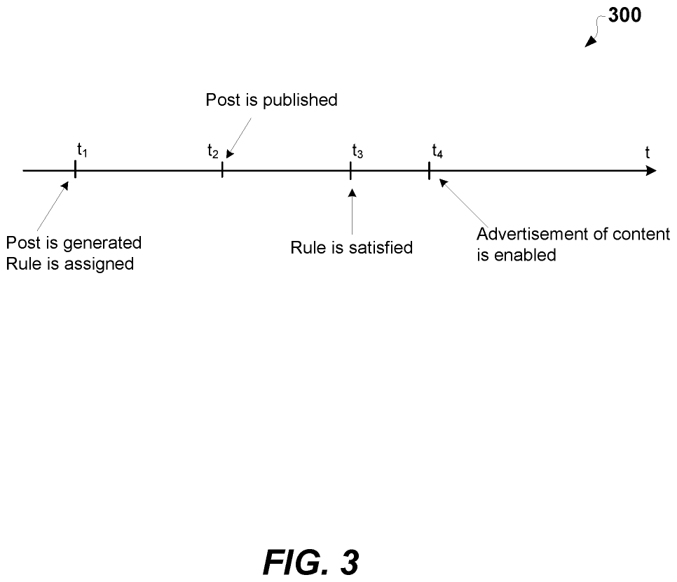

FIG. 3 is a schematic showing a timeline 300 of operations of the post and advertisement managing system 130, according to an example embodiment. At time t1, the system 130 shown in FIG. 2 may receive a social network post and assign a rule for enabling advertisement of content for the social network post. The social network post may be received along with a publishing time for the social network post to be published in one or more accounts of the user in one or more social networks. The publishing time may include time t2. At time t2, the system 130 may publish the social network post in the one or more accounts of the user in the one or more social networks.

Upon publishing the social network post, the system 130 may continuously monitor the statistics associated with the published social network post in the one or more social networks. Based on the statistics, the system 130 may determine whether the rule for enabling the advertisement of content is satisfied. At time t3, the system 130 may determine that the rule is satisfied. In response to the determination that the rule is satisfied, the system 130 may enable, at time t4, the advertisement of the content for the published social network post in the one or more social networks. Therefore, the advertisement of the content is enabled automatically only after the social network post has been published and the rule has been satisfied for the published social network post.

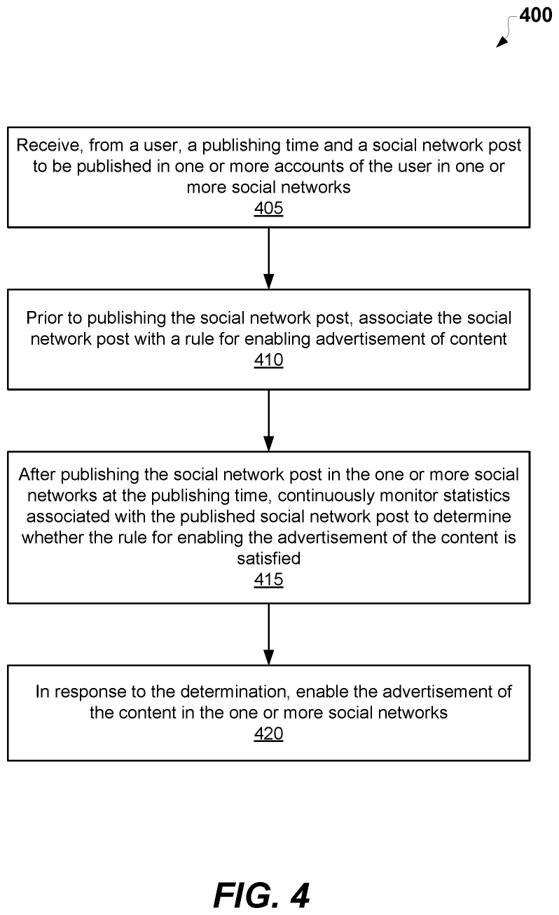

FIG. 4 is a flow chart showing a method 400 for managing advertisements in social networks, according to an example embodiment. The method 400 can be implemented in the environment 100 of FIG. 1 by the post and advertisement managing system 130. In some embodiments, the operations of method 400 may be combined, performed in parallel, or performed in a different order. The method 400 may also include additional or fewer operations than those illustrated.

The method 400 may commence in block 405 with receiving, from a user, a publishing time and a social network post to be published in one or more accounts of the user in one or more social networks. At block 410, prior to being published, the social network post may be associated with a rule for enabling advertisement of content. The rule may be based partially on statistics associated with the social network post in the one or more social networks. In an example embodiment, the user may be provided with a user interface allowing the user to select the rule from a list of predetermined rules. In a further example embodiment, the user may be provided with a user interface allowing the user to create and edit the rule.

In an example embodiment, the content to be advertised can be provided by users of the system 130.

At block 415, after the social network post has been published, statistics associated with the published social network post may be continuously monitored in the one or more social networks to determine, based on the statistics, that the rule for enabling the advertisement of the content is satisfied. The statistics may be monitored via an API of the one or more social networks. In an example embodiment, the statistics may be monitored by analyzing a page of an Internet browser that includes the published social network post in the one or more social networks. In further example embodiments, the statistics may be requested from the social networks using the APIs associated with the social networks.

The determination that the rule for enabling the advertisement of the content is satisfied may include determination that current time exceeds the publishing time by a predetermined value. In a further example embodiment, it may be determined that the rule for enabling the advertisement content is satisfied when the published social network post has been viewed a predetermined number of times. In a further example embodiment, it may be determined that the rule for enabling the advertisement content is satisfied when the published social network post has received a predetermined number of reactions, such as likes, dislikes, reposts, and so forth. The determination that the rule for enabling the advertisement of the content is satisfied may further include determination that the published social network post has received a pre-determined number of comments.

At block 420, in response to the determination that the rule for enabling the advertisement of the content is satisfied, the advertisement of the content may be enabled in the one or more social networks.

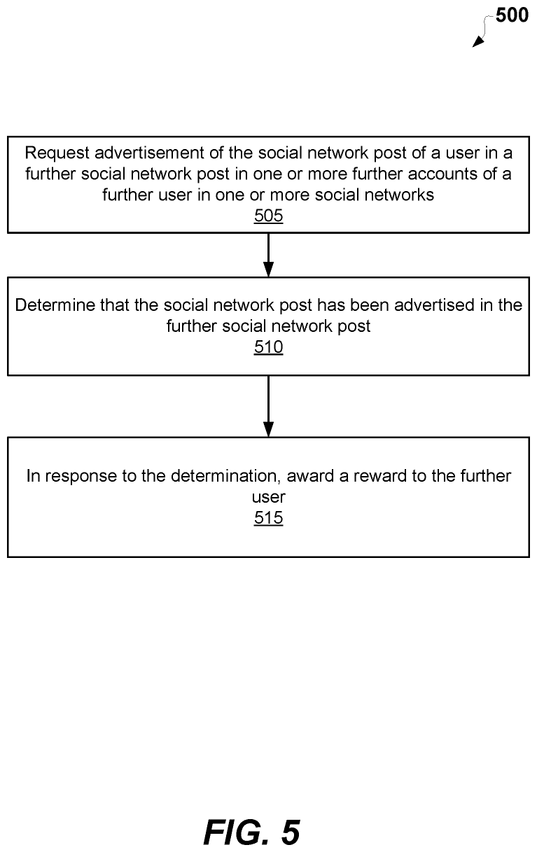

FIG. 5 is a flow chart showing a method 500 for enabling advertisements in social networks, according to an example embodiment. The method of FIG. 5 may provide details for the step 420 of the method 400 of FIG. 4. The method 500 can be implemented in the environment 100 of FIG. 1 by the post and advertisement managing system 130. The method 500 may commence in block 505 with requesting advertisement of the social network post of a user in a further social network post in one or more further accounts of a further user in one or more social networks. The further user may be associated with one of the user accounts 110-1, 110-2, . . . , 110-N and user communities 115-1, 115-2, . . . , 115-L.

In block 510, the method 500 may include determining that the social network post has been advertised in the further social network post.

In block 515, the method 500 may include awarding a reward to the further user. The reward may depend on statistics of the further user (e.g., a number of followers) in the one or more social networks.

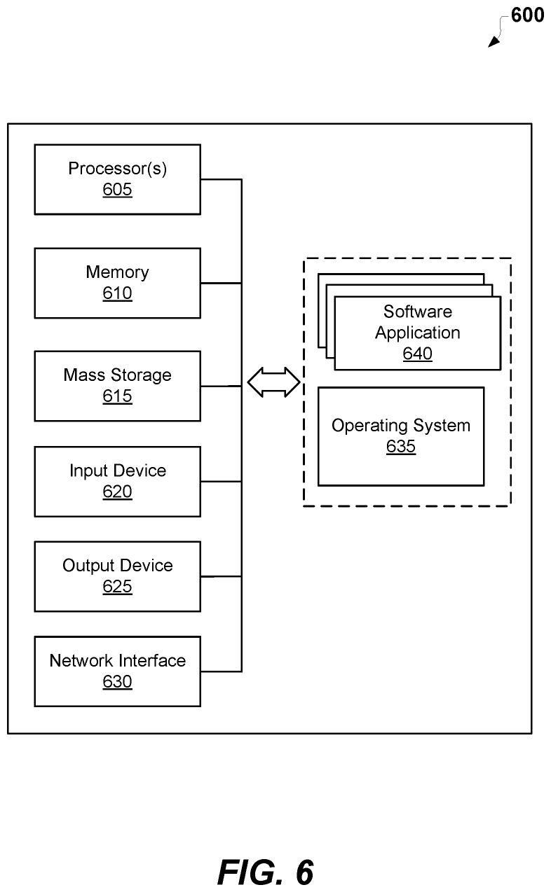

FIG. 6 is a high-level block diagram illustrating an example computer system 600, within which a set of instructions for causing the machine to perform any one or more of the methodologies discussed herein can be executed. The computer system 600 may include, refer to, or be an integral part of, one or more of a variety of types of devices, such as a general-purpose computer, desktop computer, laptop computer, tablet computer, netbook, mobile phone, smartphone, personal digital computer, smart television device, and server, cloud-based computing resources, among others. In some embodiments, the computer system 600 is an example of a post and advertisement managing system 130, or social network(s) 150-I (I=1, . . . , M). Notably, FIG. 6 illustrates just one example of the computer system 600 and, in some embodiments, the computer system 600 may have fewer elements/modules than shown on FIG. 6 or more elements/modules than shown on FIG. 6.

The computer system 600 includes one or more processors 605, a memory 610, one or more storage devices 615, one or more input devices 620, one or more output devices 625, and network interface 630. One or more processors 605 are, in some examples, configured to implement functionality and/or process instructions for execution within the computer system 600. For example, the processors 605 may process instructions stored in memory 610 and/or instructions stored on storage devices 615. Such instructions may include components of an operating system 635 or software applications 640. Computer system 600 may also include one or more additional components not shown in FIG. 6, such as a housing, power supply, battery, global positioning system receiver, and so forth.

Memory 610, according to one example, is configured to store information within the computer system 600 during operation. Memory 610, in some example embodiments, may refer to a non-transitory computer-readable storage medium or a computer-readable storage device. In some examples, memory 610 is a temporary memory, meaning that a primary purpose of memory 610 may not be long-term storage. Memory 610 may also refer to a volatile memory, meaning that memory 610 does not maintain stored contents when memory 610 is not receiving power. Examples of volatile memories include random access memories, dynamic random access memories, static random access memories, and other forms of volatile memories known in the art. In some examples, memory 610 is used to store program instructions for execution by the processors 605. Memory 610, in one example, is used by software (e.g., the operating system 635 or applications 640). Generally, software applications 640 refer to software applications suitable for implementing at least some operations of the methods for providing a location-based gaming experience as described herein.

One or more storage devices 615 can also include one or more transitory or non-transitory computer-readable storage media and/or computer-readable storage devices. In some embodiments, storage devices 615 may be configured to store greater amounts of information than memory 610. Storage devices 615 may further be configured for long-term storage of information. In some examples, the storage devices 615 include non-volatile storage elements. Examples of such non-volatile storage elements include magnetic hard discs, optical discs, solid-state discs, flash memories, forms of electrically programmable memories or electrically erasable and programmable memories, and other forms of non-volatile memories known in the art.

Still referencing to FIG. 6, the computer system 600 may also include one or more input devices 620. The input devices 620 may be configured to receive input from a user through tactile, audio, video, or biometric channels. Examples of input devices 620 may include a keyboard, keypad, mouse, trackball, touchscreen, touchpad, microphone, one or more video cameras, image sensors, fingerprint sensors, or any other device capable of detecting an input from a user or other source, and relaying the input to computer system 600, or components thereof.

The output devices 625, in some examples, may be configured to provide output to a user through visual or auditory channels. Output devices 625 may include a video graphics adapter card, a liquid crystal display monitor, a light emitting diode (LED) monitor, an organic LED monitor, a sound card, a speaker, a lighting device, a LED, a projector, or any other device capable of generating output that may be intelligible to a user. Output devices 625 may also include a touchscreen, presence-sensitive display, or other input/output capable displays known in the art.

The computer system 600, in some example embodiments, also includes network interface 630. The network interface 630 can be utilized to communicate with external devices via one or more data networks such as one or more wired, wireless, or optical networks including, for example, the Internet, intranet, LAN, WAN, cellular phone networks, Bluetooth radio, and an IEEE 902.11-based radio frequency network, among others. The network interface 630 may be a network interface card, such as an Ethernet card, an optical transceiver, a radio frequency transceiver, or any other type of device that can send and receive information.

The operating system 635 may control one or more functionalities of computer system 600 and/or components thereof. For example, the operating system 635 may interact with the applications 640 and may facilitate one or more interactions between the applications 640 and components of the computer system 600. As shown in FIG. 6, the operating system 635 may interact with or be otherwise coupled to the application(s) 640 and components thereof. In some embodiments, application(s) 640 may be included in operating system 635. In these and other examples, virtual modules, firmware, or software may be part of the applications 640.

Thus, methods of and systems for managing advertisements in social networks have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

1. A system for managing advertisements in social networks, the system comprising:
one or more processors; and
a memory storing processor-executable codes, wherein the one or more processors are configured to implement the following operations upon executing the processor-executable codes:
receiving, from a user, using a user interface, a future publishing time and a social network post to be published in one or more accounts of the user in one or more social networks;
prior to publishing the social network post, associating the social network post with a rule for enabling advertisement of content, the rule being based partially on statistics to be associated with the social network post in the one or more social networks, the rule being assigned to the social network post by the user using the user interface at a time of providing the social network post by the user, wherein the user interface is configured to provide one or more recommendations to the user regarding parameters to be selected for the rule by the user;
after publishing, using an application programming interface associated with the one or more social networks, the social network post in the one or more social networks at the future publishing time, continuously monitoring the statistics associated with the published social network post in the one or more social networks;
determining, based on the statistics, that values of data collected in the statistics have reached predetermined values;
based on the determination that the predetermined values have been reached, determining that the rule for enabling the advertisement of the content is satisfied; and
in response to the determination that the rule is satisfied, automatically enabling, by the one or more processors, without requesting an approval from the user, the advertisement of the content in the one or more social networks, wherein the enabling of the advertisement of the content is performed in association with the social network post and includes:
publishing, using the application programming interface, the social network post via a further social network post in at least one of the one or more accounts of the user and one or more accounts associated with third parties; and
adding, using the application programming interface, the content to the social network post already published, wherein the content is provided by one of the one or more social networks and the third parties.

2. The system of claim 1, wherein the determination that the rule for enabling the advertisement of the content is satisfied includes determination of one or more of the following:
a current time exceeds the future publishing time by a predetermined value;
the published social network post has been viewed a predetermined number of times;
the published social network post has received a predetermined number of reactions; and
the published social network post has received a pre-determined number of comments.

3. The system of claim 1, wherein the statistics are monitored via the application programming interface of the one or more social networks.

4. The system of claim 1, wherein the statistics are monitored by analyzing a page of an Internet browser, the page including the published social network post in the one or more social networks.

5. The system of claim 1, wherein the user interface is configured to allow the user to select the rule from a list of predetermined rules.

6. The system of claim 1, wherein the user interface is configured to allow the user to create and edit the rule.

7. The system of claim 1, wherein the enabling of the advertisement of the content includes requesting the one or more social networks to advertise the social network post.

8. The system of claim 1, wherein the enabling the advertisement of the content includes requesting advertisement of the social network post in the further social network post in one or more further accounts of a further user in the one or more social networks.

9. The system of claim 8, wherein the one or more processors are further configured to award, after enabling the advertisement of the content, a reward to the further user.

10. The system of claim 9, wherein the reward depends on statistics of the further user in the one or more social networks.

11. A method for managing advertisements in social networks, the method comprising:
receiving, from a user, using a user interface, a future publishing time and a social network post to be published in one or more accounts of the user in one or more social networks;
prior to publishing the social network post, associating the social network post with a rule for enabling advertisement of the content, the rule being based partially on statistics to be associated with the social network post in the one or more social networks, the rule being assigned to the social network post by the user using the user interface at a time of providing the social network post by the user, wherein the user interface is configured to provide one or more recommendations to the user concerning parameters to be selected for the rule by the user;
after publishing, using an application programming interface associated with the one or more social networks, the social network post in the one or more social networks at the future publishing time, continuously monitoring the statistics associated with the published social network post in the one or more social networks;
determining, based on the statistics, that values of data collected in the statistics have reached predetermined values;
based on the determination that the predetermined values have been reached, determining that the rule for enabling the advertisement content is satisfied; and
in response to the determination that the rule is satisfied, automatically enabling, without requesting an approval from the user, the advertisement of the content in the one or more social networks, wherein the enabling of the advertisement of the content is performed in association with the social network post and includes:
publishing, using the application programming interface, the social network post via a further social network post in at least one of the one or more accounts of the user and one or more accounts associated with third parties; and
adding, using the application programming interface, the content to the social network post already published, wherein the content is provided by one of the one or more social networks and the third parties.

12. The method of claim 11, wherein the determination that the rule for enabling the advertisement of the content is satisfied includes determination of one or more of the following:
a current time exceeds the future publishing time by a predetermined value;
the published social network post has been viewed a predetermined number of times;
the published social network post has received a predetermined number of reactions; and
the published social network post has received a pre-determined number of comments.

13. The method of claim 11, wherein the statistics are monitored via the application programming interface of the one or more social networks.

14. The method of claim 11, wherein the statistics are monitored by reading a page of an Internet browser, the page including the published social network post in the one or more social networks.

15. The method of claim 11, further comprising enabling, by the user interface, the user to select the rule from a list of predetermined rules.

16. The method of claim 11, further comprising enabling, by the user interface, the user to create and edit the rule.

17. The method of claim 11, wherein the enabling of the advertisement of the content includes requesting the one or more social networks to advertise the social network post.

18. The method of claim 11, wherein the enabling the advertisement of the content includes requesting advertisement of the social network post in the further social network post in the one or more further accounts of a further user in the one or more social networks.

19. The method of claim 18, further comprising, after advertisement of the social network post, awarding a reward to the further user.

20. A non-transitory processor-readable medium having instructions stored thereon, which when executed by one or more processors, cause the one or more processors to implement a method for managing advertisements in social networks, the method comprising:
receiving, from a user, using a user interface, a future publishing time and a social network post to be published in one or more accounts of the user in one or more social networks;
prior to publishing, using an application programming interface associated with the one or more social networks, the social network post, associating the social network post with a rule for enabling advertisement of content, the rule being based partially on statistics to be associated with the social network post in the one or more social networks, the rule being assigned to the social network post by the user using the user interface at a time of providing the social network post by the user, wherein the user interface is configured to provide one or more recommendations to the user concerning parameters to be selected for the rule by the user;
after publishing the social network post in the one or more social networks at the future publishing time, continuously monitoring the statistics associated with the published social network post in the one or more social networks;
determining, based on the statistics, that values of data collected in the statistics have reached predetermined values;
based on the determination that the predetermined values have been reached, determining that the rule for enabling the advertisement of the content is satisfied; and
in response to the determination that the rule is satisfied, automatically enabling, by the one or more processors, without requesting an approval from the user, the advertisement of the in the one or more social networks, wherein the enabling of the advertisement of the content is performed in association with the social network post and includes:
publishing, using the application programming interface, the social network post via a further social network post in at least one of the one or more accounts of the user and one or more accounts associated with third parties; and
adding, using the application programming interface, the content to the social network post already published, wherein the content is provided by one of the one or more social networks and the third parties.
